(19) United States
(12) Patent Application Publication
(10) Pub. No.: US 2009/0204581 A1
(43) Pub. Date: Aug. 13, 2009

(54) METHOD AND APPARATUS FOR INFORMATION PROCESSING BASED ON CONTEXT, AND COMPUTER READABLE MEDIUM THEREOF

(75) Inventor: Yong-jun LIM, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/204,164

(22) Filed: Sep. 4, 2008

(30) Foreign Application Priority Data
Feb. 12, 2008 (KR) 2008-12612

(51) Int. Cl. G06F 17/30; G06F 7/00

(52) U.S. Cl. 707/3; 707/E17.108

(57) ABSTRACT

A method and apparatus for context based information processing, and a computer recording medium including the same, the information searching method including: analyzing a query input by a user; searching information based on personal context with reference to the analysis result; searching information based on neighbor context with reference to the analysis result; and searching information based on web context with reference to the analysis result. Accordingly, a personal information processing apparatus can collect, analyze, and arrange data on the daily life of a user without intervention of the user. In addition, the personal information processing apparatus provides an information search function based not only on personal context but also neighbor context and web context. Thus, an efficient and accurate personal information search function is provided.

### CROSS-REFERENCE TO RELATED APPLICATION

This application claims all benefits accruing under 35 U.S.C. §119 from Korean Patent Application No. 2008-12612, filed on Feb. 12, 2008 in the Korean Intellectual Property Office, the disclosure of which is incorporated herein by reference.

### BACKGROUND OF THE INVENTION

1. Field of the Invention

Aspects of the present invention relate to a method and apparatus for information processing, and more particularly, to a method and apparatus for searching personal information based on context.

2. Description of the Related Art

A conventional apparatus to collect and search for personal information (such as a personal computer or a personal digital assistant (PDA)) has much less utility than a large capacity search engine due to limited information collecting resources, limited information storage capacity, shortage of search tools, etc. For example, a user collects information using a PDA by directly inputting data (active log) to the PDA (e.g., a keyboard input, a photographed image input, etc.). In addition, information stored in the PDA is searched by a directory operation method or a keyword search method, which are still primitive methods.

However, due to recently developed technology in information storage, an apparatus for collecting and/or searching personal information can now store an enormous amount of information. For example, besides a conventional active log method, passive logs that are automatic information collecting devices (such as a global positioning system (GPS) or a clock for collecting information about the daily life of a user) are coupled to a personal information device. Accordingly, there is a limitation in terms of how quickly and efficiently the enormous amount of information can be searched by using conventional search methods.

One conventional influential information search method is a context-based search method. Examples of prior patent publications related to the context-based search method include “Context-aware computing devices and methods” (U.S. Pat. No. 7,213,048), “System and method for searching and recommending objects from a categorically organized information repository” (U.S. Pat. No. 7,031,961), and “Personal information database with context-driven information retrieval” (U.S. Patent Application No. 2007-0011158).

In U.S. Pat. No. 7,213,048, when the user inputs a theme and context and feedbacks relevance therebetween, appropriate information is recommended to the user based on popularity, retrieval frequency, recent access, etc. by a database. In this method, the user directly provides context and searches information according to algorithms employed by the user using a commercial search engine, and thus the user terminal and the search service supplier interact based on a client-server relationship.

U.S. Pat. No. 7,031,961 discloses a method in which context is provided from a context source and a context service module operating in connection with an application renews the current context or transfers information for the context to the application. However, in this case, the operation of the context service module is from a structural perspective only, and a method of providing optimum information to the context is not mentioned.

U.S. Patent Application No. 2007-0011158 relates to a method in which, when an information request including identification is input, information is searched according to a context included in the information request. However, this patent application mentions only switching information linked to the database, and a method of using the context is not mentioned in detail.

As described above, the conventional information search methods do not provide an efficient and accurate information search for searching information by using a personal information collecting/searching apparatus.

### SUMMARY OF THE INVENTION

Several aspects and example embodiments of the present invention provide a method and apparatus for efficient information processing, and a computer program storage medium for executing the method on a computer.

Additional aspects and/or advantages of the invention will be set forth in part in the description which follows and, in part, will be obvious from the description, or may be learned by practice of the invention.

In accordance with an example embodiment of the present invention, there is provided a method of searching information based on context through a personal computing apparatus, the method including: analyzing a query input by a user to the personal computing apparatus; searching information on the personal computing apparatus based on personal context with reference to a result of the analyzing of the query; searching information on a member of a neighbor group based on neighbor context with reference to the result of the analyzing of the query; and searching information on a member of a web based on web context with reference to the result of the analyzing of the query.

In accordance with another example embodiment of the present invention, there is provided a method of searching information based on context through a personal computing apparatus, the method including: analyzing a query input by a user to the personal computing apparatus; searching information on the personal computing apparatus based on personal context with reference to a result of the analyzing of the query; determining whether the searched information based on the personal context is satisfactory; and if the searched information based on the personal context is determined to not be satisfactory, searching information on a member of a neighbor group based on neighbor context with reference to the result of the analyzing of the query and/or performing a personal/neighbor context based search to obtain a best searched information.

In accordance with yet another example embodiment of the present invention, there is provided a computer readable recording medium having embodied thereon a computer program for executing a method of information searching, wherein the method includes: analyzing a query input by a user; searching information based on personal context with reference to a result of the analyzing of the query; searching information based on neighbor context with reference to the result of the analyzing of the query; and searching information based on web context with reference to the result of the analyzing of the query.

In accordance with still another example embodiment of the present invention, there is provided a computer readable recording medium having embodied thereon a computer program for executing a method of information searching, wherein the method includes: analyzing a query input by a user to the personal computing apparatus; searching information on the personal computing apparatus based on personal context with reference to a result of the analyzing of the query; determining whether the searched information based on the personal context is satisfactory; and if the searched information based on the personal context is determined to not be satisfactory, searching information on a member of a neighbor group based on neighbor context with reference to the result of the analyzing of the query and/or performing a personal/neighbor context based search to obtain a best searched information.

In accordance with another example embodiment of the present invention, there is provided an information processing apparatus to search information based on context, the information processing apparatus including: a personal context managing unit to extract personal context from stored personal information; a context based interface to extract a query context from a query of a user; and an integrated data processing unit to search information by using the personal context extracted by the personal context managing unit and the query context extracted by the context based interface.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a schematic view illustrating an information processing system according to an example embodiment of the present invention;

FIG. 2 is a block diagram illustrating a hardware configuration of a personal information processing apparatus according to an example embodiment of the present invention;

FIG. 3 is a flowchart illustrating detailed operations of an information processing method according to an example embodiment of the present invention;

FIG. 4 is a flowchart illustrating an information processing method according to another example embodiment of the present invention;

FIG. 5 is a flowchart illustrating an information processing method according to another example embodiment of the present invention; and

FIG. 6 is a flowchart illustrating an information processing method according to another example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 1 is a schematic view illustrating an information processing system according to an example embodiment of the present invention. Referring to FIG. 1, the information processing system includes a personal information processing apparatus 11, a personal information collecting unit 12, a neighbor group 13, and a web 14.

The personal information collecting unit 12 collects data on a daily life of a user using the personal information processing apparatus 11. That is, the personal information collecting unit 12 collects various data on behavior, emotions, thoughts, and/or other experiences the user goes through in daily life. Accordingly, the personal information collecting unit 12 includes various sensors such as a clock to collect time information, a global positioning system (GPS) to determine a location of the user, an acceleration speed measuring sensor, a pulse measuring sensor, a temperature sensor, an electronic nose, a sound recording device, a recorder to record emotions of a user through sound/language recognition, an image recording device, a camera, etc.

The web 14 is a large scale network including one or more servers and clients (such as the Internet). For example, the web may be a network that provides a social network service.

The neighbor group 13 is a network that is relatively small compared to the web 13, such as a personal area network (PAN). Members of the neighbor group 13 (i.e., individual devices in the neighbor group 13) refer to individuals having common interests. According to aspects of the present invention, some or all members of the neighbor group 13 may also be realized as a part of the web 14.

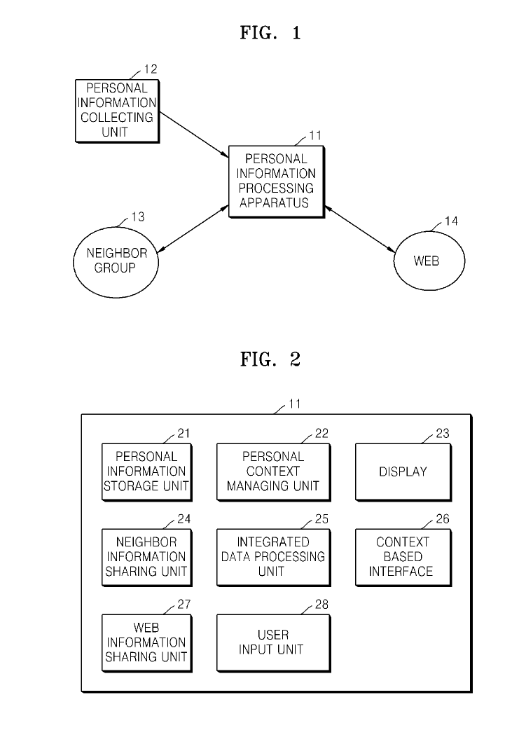

A detailed structure of the personal information processing apparatus 11 will be described later with reference to FIG. 2. In FIG. 1, the personal information collecting unit 12 is realized as a physically independent device from the personal information processing apparatus 11. However, according to other aspects of the present invention, the personal information collecting unit 12 may be realized as a part of the personal information processing apparatus 11.

FIG. 2 is a block diagram illustrating a hardware configuration of the personal information processing apparatus 11 according to an example embodiment of the present invention. Referring to FIG. 2, the personal information processing apparatus 11 includes a personal information storage unit 21, a personal context managing unit 22, a display 23, a neighbor information sharing unit 24, an integrated data processing unit 25, a context based interface 26, a web information sharing unit 27, and a user input unit 28. The personal information processing apparatus 11 may be a personal computer, a personal digital assistant (PDA), a notebook computer, etc.

The personal information processing apparatus 11 may be referred to as “Another Me” or an “electronic personal assistant” of the user. The personal information processing apparatus 11 provides functions of collecting and arranging all information related to the user and functions of searching the information.

The personal information storage unit 21 stores daily data collected by the personal information collecting unit 12. Accordingly, the personal information storage unit 21 stores data on the daily life of the user (i.e., various types of data on behavior, emotions, conditions of the user, etc.). For example, the data may be sound data, image data, text data, etc.

The personal context managing unit 22 manages personal information based on context. The personal context managing unit 22 classifies the data stored in the personal storage unit 21 according to categories or extracts keywords or contexts (hereinafter referred to as personal context) from the stored data in order to store the extracted keywords or contexts.

The context based interface 26 is an inference engine having a natural language processing function and analyzes and infers the intention or key point of the user from a query of the user. In detail, the context based interface 26 analyzes a query input through the user input unit 28 and extracts a query context used for an information search. The context based interface 26 may be personal context stored in the personal context managing unit 22.

The neighbor information sharing unit 24 receives a search request and a query context from the context based interface 26 under the control of the integrated data processing unit 25 and transmits the search request and the query context to the neighbor group 13 or receives the search result from the neighbor group 13. Accordingly, the neighbor information sharing unit 24 also functions as a network interface.

The web information sharing unit 27 receives a search request and a query context from the context based interface 26 under the control of the integrated data processing unit 25 and transmits the search request and the query context to the web 14 or receives a search result from the web 14. Accordingly, the web information sharing unit 27 also functions as a network interface.

The integrated data processing unit 25 is an artificial intelligence processor and extracts a query context from the query in cooperation with the context based interface 26. Also, the integrated data processing unit 25 controls and arbitrates interactions between the context based interface 26 and the neighbor information sharing unit 24 to help a neighbor context based search of the neighbor group 13. Also, in order to help a web context based search, the integrated data processing unit 25 controls interactions between the context based interface 26 and the web information sharing unit 27.

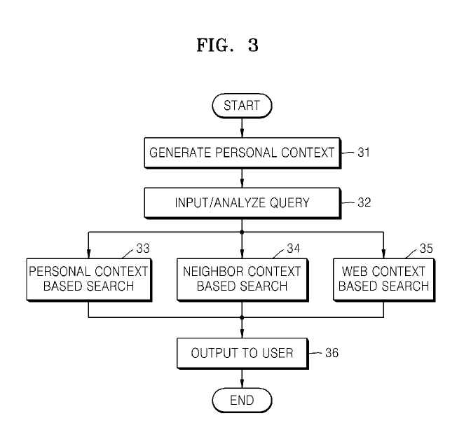

FIG. 3 is a flowchart illustrating detailed operations of an information processing method according to an example embodiment of the present invention. Referring to FIG. 3, personal context (or my context) is generated in operation 31. The personal context managing unit 22 classifies data stored in the personal information storage unit 21 according to categories or extracts keywords or context (hereinafter referred to as personal context) from the data stored in the personal information storage unit 21 to store the extracted keywords or context.

Next, a query is input and analyzed in operation 32. Specifically, the user inputs a search query to the context based interface 26 through the user input unit 28. A search query may be one or more words or a sentence. The context based interface 26 extracts a query context used for an information search by analyzing the input search query. In extracting a query context, the context based interface 26 may refer to the personal context stored in the personal context managing unit 22.

In operation 33, data is searched based on personal context. Specifically, the integrated data processing unit 25 compares the query context obtained in operation 32 with personal context stored in the personal context managing unit 22 and selects a personal context accordingly. Then, the personal information storing unit 22 is searched or accessed using the selected personal context to retrieve information corresponding to the query.

In operation 34, data is searched based on neighbor context. Specifically, the integrated data processing unit 25 transmits the query context obtained from the context based interface 26 to the neighbor information sharing unit 24. The neighbor information sharing unit 24 transmits an information search request and the query context to the neighbor group 13. A member of the neighbor group 13 selects a neighbor context using the received query context. Then, by using the selected neighbor context, appropriate information is retrieved from the member of the neighbor group 13 and transmitted to the personal information processing apparatus 11.

In order to perform the operation 34, the member of the neighbor group 13 may be determined in advance. The neighbor group 13 includes some devices selected from among devices connected to a network. The neighbor group 13 may be determined differently according to the content of the query. For example, if a query is about American dramas, people who frequently watch American dramas or who frequently search the Internet about American dramas are determined as members of the neighbor group 13.

In operation 35, data is searched based on web context. Specifically, the web information sharing unit 27 transmits a query context received from the context based interface 26 to the web 14 together with an information search request. Devices of the web 14 (for example, a home server) select a web context by using the received query context. Then, the web devices use the selected web context to retrieve appropriate information from among their own stored information and transmit the information to the personal information processing apparatus 11.

In operation 36, the information retrieved in operations 33 through 35 is output to the user through the display 23 or a speaker.

Hereinafter, a method with reference to FIG. 3 will be described with reference to an example query. First, the user inputs a query, “How is Chan Ho Park performing in baseball recently?” in operation 32. The context based interface 26 performs a function of natural language processing on the query in order to extract a context. For example, based on the word “recently”, a context of within three days is extracted; based on the name “Chan Ho Park”, “Chan Ho Park” and “baseball player” are extracted; and based on “performing in baseball”, “earned run average (ERA)” is extracted in operation 32. The integrated data processing unit 25 compares the extracted query context with the personal context stored in the personal context managing unit 22 to select appropriate personal context. The integrated data processing unit 25 uses the selected personal context to search corresponding information from the personal information storage unit 22. For example, if the user has watched a game starring Chan Ho Park or has surfed the Internet about this game, within three days of making the query, data in this regard is stored and thus the integrated data processing unit 25 will extract the information in operation 33.

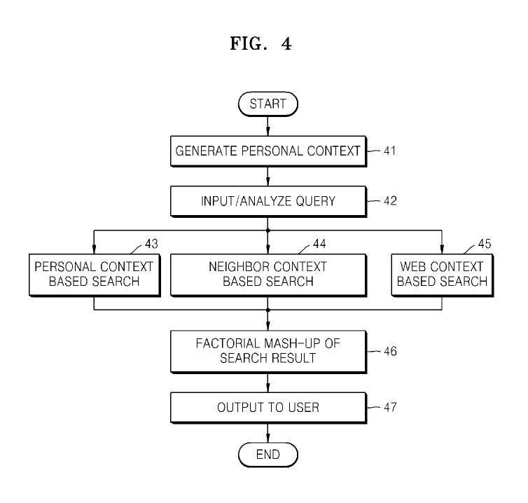

FIG. 4 is a flowchart illustrating an information processing method according to another example embodiment of the present invention. Some of the operations of the information processing method of FIG. 4 (operations 41 through 45) correspond to the operations of the information processing method of FIG. 3 (operations 31 through 36). However, the method with reference to FIG. 4 further includes an operation 46 of a factorial mash-up. A mash-up refers to editing retrieved information. For example, a mash-up may add a search result A of a search performed in operation 43 to a search result B of a search performed in operation 44, may delete repeated information, and/or may modify information. A factorial mash-up is a mash-up for all possible combinations of two or more search results. For example, if the search result of a search performed in operation 45 is C, a factorial mash-up is a mash-up operation performed on A, B, C, AB, BC, CA, and ABC.

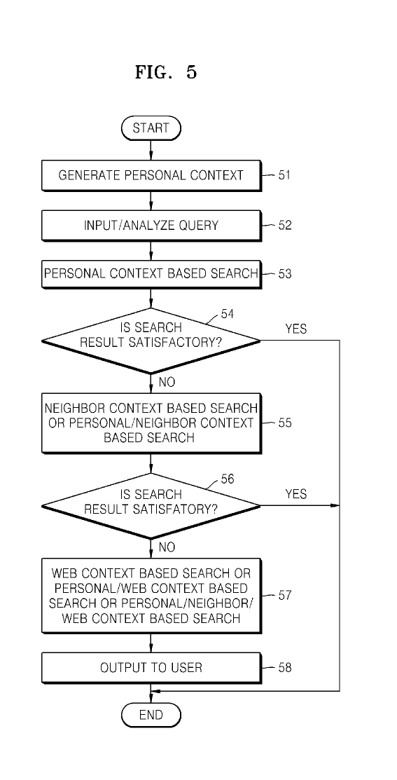

FIG. 5 is a flowchart illustrating an information processing method according to another example embodiment of the present invention. Since some of operations of the method of FIG. 5 correspond to some of the operations of the method of FIG. 3, the description of the method of FIG. 5 will focus on the differences therebetween.

Referring to FIG. 5, the integrated data processing unit 25 determines whether the search result of a search based on personal context (operation 53) is satisfactory in operation 54. The integrated data processing unit 25 determines whether the search result corresponds to a predetermined standard in terms of quality and quantity. For example, if the amount of retrieved information is less than a predetermined threshold value (for example, 50), the search result may be determined to be unsatisfactory.

In operation 55, data is searched based on neighbor context and/or personal/neighbor context. Specifically, if the search result based on the personal context (operation 53) is not satisfactory (operation 54), the integrated data processing unit 25 sends an information search request to the neighbor group 13 and receives a search result based on neighbor context. According to aspects of the present invention, the integrated data processing unit 25 may compare and analyze the search result based on the personal context and the search result based on the neighbor context to select the most appropriate information (i.e., a personal/neighbor context based search).

In operation 56, the integrated data processing unit 25 determines, again, whether the search result of operation 55 is satisfactory. Specifically, if the search result is not satisfactory (operation 56), a web context based search, a personal/web context based search, and/or a personal/neighboring/web context based search is performed in operation 57. The web context based search here corresponds to the web context based search of operation 35 of FIG. 3. The personal/web context based search compares and/or analyzes the personal context based search result and the web context based search result in order to select appropriate information. The personal/neighboring/web context based search refers to comparing and/or analyzing all of the personal context based search result, the neighbor context based search result, and the web context based search result in order to select appropriate information.

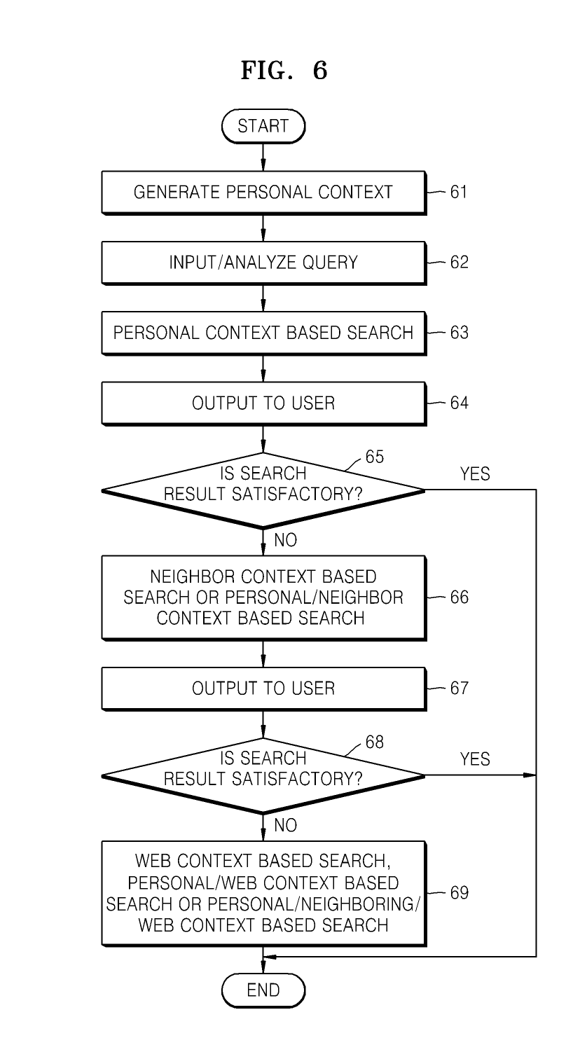

FIG. 6 is a flowchart illustrating an information processing method according to another example embodiment of the present invention. Since some of the operations of the method of FIG. 6 correspond to the operations constituting the method of FIG. 5, the description on the method of FIG. 6 will focus on differences therebetween. As compared to the method of FIG. 5, the information processing method of FIG. 6 further includes outputting operations of the search result to the user (operations 64 and 67). In operations 64 and 67, the integrated data processing unit 25 outputs the search result to the user through a display. Accordingly, in operations 65 and 68, the user examines the search result, and if the search result is satisfactory, the user ends the process. If the search result is not satisfactory, an additional search is performed in operation 66 and/or 69.

The operations of the information processing methods of FIGS. 3 through 6 are not restricted to the order defined in FIGS. 3 through 6. That is, in other example embodiments of the present invention, the order of the operations of FIGS. 3 through 6 may be different.

Aspects of the invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer readable code is stored and executed in a distributed fashion. Aspects of the present invention may also be realized as a data signal embodied in a carrier wave and comprising a program readable by a computer and transmittable over the Internet. Also, functional programs, codes, and code segments for accomplishing aspects of the present invention can be easily construed by programmers skilled in the art to which the present invention pertains.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, a neighbor context based search (operation 34 in FIG. 3) and/or a web context based search (operation 35 in FIG. 3) may be omitted in other example embodiments of the present invention. Accordingly, it is intended, therefore, that the present invention not be limited to the various example embodiments disclosed, but that the present invention includes all embodiments falling within the scope of the appended claims.

What is claimed is:

1. A method of searching information based on context through a personal computing apparatus, the method comprising:
analyzing a query input by a user to the personal computing apparatus;
searching information on the personal computing apparatus based on personal context with reference to a result of the analyzing of the query;
searching information on a member of a neighbor group of computing apparatuses based on neighbor context with reference to the result of the analyzing of the query; and
searching information on a member of a web based on web context with reference to the result of the analyzing of the query.

2. The method as claimed in claim 1, further comprising generating the personal context from data stored in the personal computing apparatus.

3. The method as claimed in claim 1, wherein the analyzing of the query comprises extracting a query context from the query, the query context being the result of the analyzing of the query.

4. The method as claimed in claim 3, wherein the extracting of the query context comprises extracting the query context with reference to the personal context.

5. The method as claimed in claim 1, further comprising performing a factorial mash-up of the searched information based on the personal context, the searched information based on the neighbor context, and/or the searched information based on the web context.

6. The method as claimed in claim 1, wherein the searching of the information on the member of the neighbor group comprises:
transmitting a query context to the neighbor group, the query context being the result of the analyzing of the query; and
receiving a result of the searching from the neighbor group.

7. The method as claimed in claim 6, wherein the searching of the information on the member of the neighbor group further comprises:
selecting the neighbor context using the query context; and
searching the information using the neighbor context.

8. The method as claimed in claim 1, wherein the searching of the information on the member of the neighbor group comprises determining the member of a neighbor group in advance.

9. The method as claimed in claim 1, wherein the searching of the information on the member of the web comprises:
transmitting a query context to the web, the query context being the result of the analyzing of the query; and
receiving a result of the searching from the web.

10. The method as claimed in claim 9, wherein the searching of the information on the member of the web further comprises:
selecting the web context using the query context; and
searching the information using the web context.

11. The method as claimed in claim 2, wherein the generating of the personal context comprises generating the personal context by classifying the data stored in the personal computing apparatus according to categories as the personal context or extracting keywords as the personal context from the data stored in the personal computing apparatus.

12. The method as claimed in claim 1, wherein the web is the Internet.

13. The method as claimed in claim 1, further comprising outputting the searched information based on the personal context, the searched information based on the neighbor context, and/or the searched information based on the web context.

14. The method as claimed in claim 3, further comprising generating the personal context from data stored in the personal computing apparatus,
wherein the searching of the information based on the personal context comprises comparing the extracted query context with the generated personal context.

15. A method of searching information based on context through a personal computing apparatus, the method comprising:
analyzing a query input by a user to the personal computing apparatus;
searching information on the personal computing apparatus based on personal context with reference to a result of the analyzing of the query;
determining whether the searched information based on the personal context is satisfactory; and
if the searched information based on the personal context is determined to not be satisfactory, searching information on a member of a neighbor group based on neighbor context with reference to the result of the analyzing of the query and/or performing a personal/neighbor context based search to obtain a best searched information.

16. The method as claimed in claim 15, further comprising if the searched information based on the neighbor context and the searched information based on personal/neighbor context is not satisfactory, performing a web context based search, a personal/web context based search, and/or a personal/neighboring/web context based search to obtain the best searched information.

17. The method as claimed in claim 15, further comprising generating the personal context from data stored in the personal computing apparatus.

18. The method as claimed in claim 16, further comprising determining whether one or more of the searched information based on the personal context, the searched information based on the neighbor context, the searched information based on the web context, the searched information based on the personal/neighbor context, searched information based on the personal/web context and the searched information based on the personal/neighbor/web context correspond to the query.

19. The method as claimed in claim 18, wherein the user determines whether the one or more of the searched information based on the personal context, the searched information based on the neighbor context, the searched information based on the web context, the searched information based on the personal/neighbor context, searched information based on the personal/web context and the searched information based on the personal/neighbor/web context correspond to the query.

20. The method as claimed in claim 15, wherein the determining of whether the searched information based on the personal context is satisfactory comprises determining if an amount of searched content is greater than a predetermined value.

21. A computer readable recording medium having embodied thereon a computer program for executing the method of claim 1 and implemented by a computer.

22. A computer readable recording medium having embodied thereon a computer program for executing the method of claim 15 and implemented by a computer.

23. An information processing apparatus to search information based on context, the information processing apparatus comprising:
a personal context managing unit to extract personal context from stored personal information;
a context based interface to extract a query context from a query of a user; and
an integrated data processing unit to search information by using the personal context extracted by the personal context managing unit and the query context extracted by the context based interface.

24. The information processing apparatus as claimed in claim 23, further comprising a neighbor information sharing unit to search information on a member of a neighbor group by using neighbor context and the query context extracted by the context based interface.

25. The information processing apparatus as claimed in claim 24, wherein the neighbor information sharing unit transmits an information search request and the query context to the neighbor group.

26. The information processing apparatus as claimed in claim 23, further comprising a web information sharing unit to search information on a member of a web by using web context and the query context extracted by the context based interface.

27. The information processing apparatus as claimed in claim 26, wherein the web information sharing unit transmits an information search request and the query context to the web.

28. The information processing apparatus as claimed in claim 23, wherein the context based interface is an inference engine having a function of natural language processing.

29. The information processing apparatus as claimed in claim 23, further comprising a personal information storage unit to store the personal information.

30. The information processing apparatus as claimed in claim 23, further comprising a personal information collecting unit to collect data on a daily life of the user as the personal information.

31. The information processing apparatus as claimed in claim 23, wherein the integrated data processing unit compares the personal context with the query context to search the information.

32. The information processing apparatus as claimed in claim 24, wherein the integrated data processing unit performs a factorial mash-up of the searched information based on the personal context and the searched information based on the neighbor context.

33. The information processing apparatus as claimed in claim 26, wherein the integrated data processing unit performs a factorial mash-up of the searched information based on the personal context and the searched information based on the web context.
